(19) United States
(12) Patent Application Publication
(10) Pub. No.: US 2017/0048532 A1
(43) Pub. Date: Feb. 16, 2017

(54) PROCESSING ENCODED BITSTREAMS TO IMPROVE MEMORY UTILIZATION

(71) Applicant: Microsoft Technology Licensing, LLC, Redmond, WA (US)

(72) Inventors: Shyam Sadhwani, Bellevue, WA (US); Yongjun Wu, Bellevue, WA (US)

(21) Appl. No.: 14/825,589

(22) Filed: Aug. 13, 2015

(51) Int. Cl. H04N 19/39; H04N 19/33

(52) U.S. Cl. CPC H04N 19/39; H04N 19/33

(57) ABSTRACT

An encoded bitstream of video data can include layers of encoded video data. Such layers can be removed by a device in response to, for example, available bandwidth or device capabilities. The encoded bitstream also includes values for reference count parameters that are used by a video decoder to allocate memory when decoding the video data. If layers of the encoded video data are removed from the encoded bitstream, the values for these reference count parameters are modified. By modifying the values of these parameters, the video decoder allocates a different amount of memory and memory utilization is improved. Such modifications can be made by processing the encoded bitstream without re-encoding the encoded video data.

### BACKGROUND

In some computing applications, video data is compressed and processed into an encoded bitstream. The encoded bitstream is transmitted to one or more destination devices, where the video data is decoded and decompressed, and then displayed or otherwise processed. An encoded bitstream typically conforms to an established standard.

An example of such a standard is a format called ISO/IEC 14496-10 (MPEG-4 Part 10), also called ITU-T H.264, or simply Advanced Video Coding (AVC) or H.264. Herein, a bitstream that is encoded in accordance with this standard is called an AVC-compliant bitstream. An example of such a standard is a format called ISO/IEC 23008-2 MPEG-H Part 2, also called ITU-T H.265, or simply High Efficiency Video Coding (HEVC) or H.265. Herein, a bitstream that is encoded in accordance with this standard is called an HEVC-compliant bitstream.

Many such standards for encoding video data include a form of encoding that organizes data into hierarchical layers. Each layer encodes a subset of the video data. A base layer provides a minimal level of image quality. One or more additional layers provide increasing levels of quality. The quality can relate to, and the hierarchical layers can be based on, temporal resolution, spatial resolution or other characteristic of the image data (e.g., bit depth). Using layers, the same encoded bitstream can be used to distribute video data to different types of devices and over different types of network connections. Layers can be dropped from the encoded bitstream based on, for example, the quality of the network connection or the resolution of a target output device.

### SUMMARY

This Summary is provided to introduce a selection of concepts in a simplified form that are further described below in the Detailed Description. This Summary is intended neither to identify key or essential features of the claimed subject matter, nor to limit the scope of the claimed subject matter.

When layers are removed from an encoded bitstream, whether at the time of encoding, transmission, or decoding, the syntax of the encoded bitstream, and values for various parameters stored in the encoded bitstream, typically remain unchanged. Some of the parameters, however, are used by a video decoder to allocate memory when decoding the video data. Such parameters are called “reference count” parameters herein. For example, a parameter can indicate a number of reference frames and/or a number of frames for which buffering is to be allocated by the video decoder. If layers are removed, for example to reduce the frame rate or bit rate, and if the video decoder allocates memory based on the original values of the reference count parameters, then memory can be over-allocated. By modifying the values for the reference count parameters when layers are removed from an encoded bitstream, the video decoder allocates a different amount of memory and memory utilization is improved. Such modifications can be made by processing the encoded bitstream without re-encoding the encoded video data.

In the following description, reference is made to the accompanying drawings which form a part of this application, and in which are shown, by way of illustration, specific example implementations of this technique. It is understood that other embodiments may be utilized, and functional and structural changes may be made, without departing from the scope of the disclosure.

### DESCRIPTION OF THE DRAWINGS

FIG. 1 is a block diagram of an example operating environment of a first device transmitting encoded image data to a second device over a network connection.

FIG. 2 is a block diagram of a bitstream processor that changes metadata specifying memory allocation information.

FIG. 3 is a flow chart describing an example implementation of a bitstream processor.

FIG. 4 is a block diagram of a portion of a decoder configured to allocate memory in response to metadata in an encoded bitstream.

FIG. 5 is a flow chart describing an example implementation of processing an encoded bitstream during encoding.

FIG. 6 is a flow chart describing an example implementation of processing an encoded bitstream during transmission.

FIG. 7 is a flow chart describing an example implementation of processing an encoded bitstream during decoding.

FIG. 8 is a block diagram of an example computing device with which components of such a system can be implemented.

### DETAILED DESCRIPTION

The following section describes an example operating environment of a first device transmitting an encoded bitstream to a second device over a computer network.

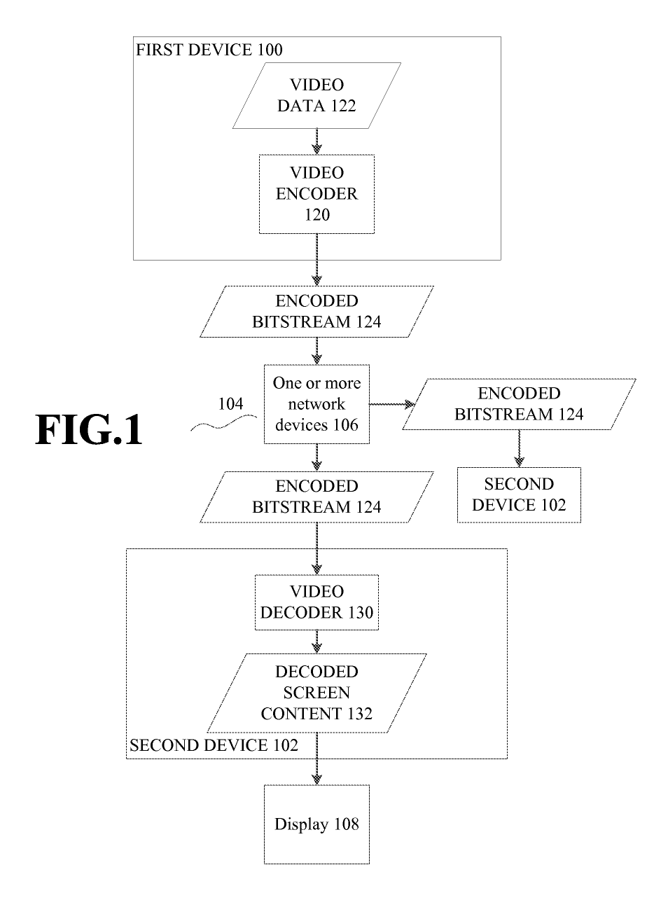

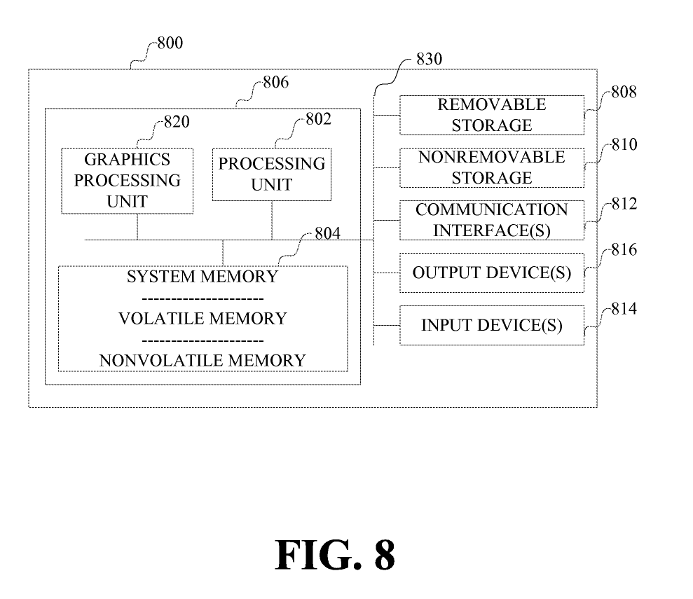

Referring to FIG. 1, this example operating environment includes a first device 100. The first device can be implemented using a general purpose computer such as described below in connection with FIG. 8 and configured with sufficient processors, memory and storage to support hosting an operating system and applications. The first device 100 can include a video encoder 120 through which the first device generates an encoded bitstream for transmission to the second device. The video encoder 120 comprises an input configured to receive input video data 122 and an output configured to provide the encoded bitstream 124. A first device can include, or can be configured to access, storage in which an encoded bitstream is stored and from which the encoded bitstream is accessed for transmission, without the first device having a video encoder.

In this example operating environment, the first device 100 is connected to one or more second devices 102 over a computer network 104. There can be a single second device, or multiple second devices. Different second devices can be connected to the computer network 104 at different times. Similarly, there can be multiple first devices. Different first devices can be connected to the computer network 104 at different times.

The second device 102 can be implemented using a general purpose computer such as described below in connection with FIG. 8 and configured with sufficient processors, memory and storage to support hosting an operating system and applications. The second device 102 includes a video decoder 130 through which the second device generates decoded video data 132, which can be displayed on a display 108, for example. The video decoder 130 comprises an input configured to receive the encoded bitstream 124 received by the second device over the computer network 104, and an output configured to provide decoded video data 132 based on at least the encoded bitstream 124. Generally, the second device can be any device that is configured with a video decoder to receive, decode and display the encoded bitstream 124 from the first device 100 over the computer network 104.

The computer network 104 can be established over any communication connection between the first device and the second device over which such devices are configured to transmit and received an encoded video bitstream. Such a communication connection can include, but is not limited to, one or more wired or wireless computer network connections, and/or one or more radio connections, over which any number of communication protocols can be used to establish the computer network. The computer network can include one or more network devices 106 that are configured to receive data and transmit data through the computer network over communication connections. Example network devices include but are not limited to routers, access points, gateways, switches or any other device that can input and output packets of data according to a networking protocol over a communication connection.

After a communication connection is established between the first device and the second device, the first device 100 is configured to be able to transmit the encoded bitstream 124 over the computer network 104 to the second device 102. During transmission of the encoded bitstream over the computer network, one or more network devices 106 can process the encoded bitstream 124 and further transmit an encoded bitstream 125 to the second device 102. In some instances, the output of a network device 106 is the encoded bitstream 124; in some instances the network device 106 processes the encoded bitstream 124, for example by dropping a layer, and encoded bitstream 125 is different from encoded bitstream 124.

Given the example operating environment of FIG. 1, such a system can be deployed in several configurations.

As an example implementation, the first device can include a personal computer, tablet computer, mobile phone or other mobile computing device, configured to support hosting an operating system and applications. The second device can be a display device with a built-in computer, such as a smart television or smart projection system, which executes a remote display application. In such an implementation, for example, a user of a mobile phone, as a host computer, can connect the mobile phone, as a first device, to an external display, as a second device.

As an example implementation, the first device can include a server computer configured to support hosting a video distribution service that provides video data to multiple customers through multiple second devices. Each second device can be configured differently, such as with a client application that provides a video player that configures the second device to access the server computer supporting the video distribution service. Such a second device can include, for example, as a personal computer, mobile computing device, tablet computer, or mobile phone. In such an implementation, for example, a user of a personal computer can connect the personal computer, as the second device, to a computer network and configure the personal computer with the client application for the video distribution service. The client application configures the second device to send requests for video over the computer network to the server computer, as the first device, and the server computer is configured to, in response to such requests, transmit encoded bitstreams for the requested video over the computer network to the second device.

As another example implementation, the first device can include, for example, a personal computer, tablet computer, mobile phone or other mobile computing device, configured to support hosting an operating system and applications. The second device can include, for example, a personal computer, mobile computing device, tablet computer, or mobile phone also configured to support hosting an operating system and applications. Both the first and second devices can include an application that implements an interactive video application, where video from the first device is transmitted over the computer network to be displayed on the second device, and video from the second device is transmitted over the computer network to be displayed on the first device.

There are many system configurations in which an encoded bitstream is transmitted from a first device to a second device, and the foregoing examples are intended to be merely illustrative and not an exhaustive description of such configurations.

In such applications, a bit rate available or useful for transmitting an encoded bitstream can be lower than the bit rate of the encoded bitstream with all of its layers. For example, the second device may not be capable of processing all layers of the encoded bitstream. As another example, the quality of a display device may be such that all layers of the encoded bitstream are not useful to decode. As another example, network utilization, congestion, or available bandwidth may limit the amount of data that can be transmitted.

In such cases, and other cases, one or more layers of the encoded bitstream can be dropped. Such dropping can occur, for example, in a video encoder in the first device, or otherwise in the first device at the time of transmission, or in a network device during transmission, or in the second device at the time of reception or storage, or in a decoder in the second device at the time of decoding. Using standards such as AVC and HEVC, when data from a layer is dropped from the encoded bitstream, the reduced encoded bitstream is still AVC-compliant or HEVC-compliant, as the case may be.

Although dropping layers reduces the bandwidth used to transmit, and reduces the amount of storage used to store, the reduced encoded bitstream, the reduced encoded bitstream otherwise maintains the syntax of the original encoded bitstream, including values for various parameters used by a video decoder. Some of the parameters, however, are used by a video decoder to specify an amount of memory to be allocated when decoding the video data. Some of the parameters, however, are used by a video decoder to allocate memory when decoding the video data. Such parameters used by a video decoder to making memory allocation decisions are called “reference count” parameters herein. For example, some parameters can indicate a number of reference frames and/or a number of frames for which buffering is to be allocated. If layers are removed, for example to reduce the frame rate or bit rate, and if the video decoder allocates memory based on the original values of the reference count parameters, then memory can be over-allocated.

Accordingly, in response to dropping one or more layers of the encoded bitstream, a bitstream processor is configured to modify the values of the reference count parameters in a reduced encoded bitstream. The values for these parameters are modified so that the video decoder in turn allocates a different amount of memory for decoding. More particularly, in the implementation shown in FIG. 1, a device (whether the first device, the network device or the second device) can include a bitstream processor, which configures the device to modify the values of the reference count parameters in the encoded bitstream and output a modified, reduced encoded bitstream. Using standards such as AVC and HEVC, the modified reduced encoded bitstream can still be AVC-compliant or HEVC-compliant, as the case may be. Such modifications can be made by processing the encoded bitstream without re-encoding the encoded video data.

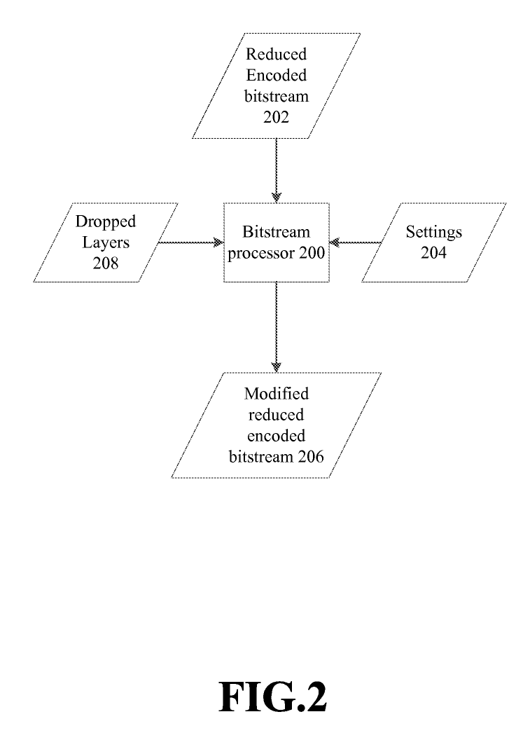

An example implementation of such a bitstream processor is shown in FIG. 2. This example is based on an implementation for processing AVC or HEVC-compliant bitstreams and dropping of temporal layers. Other implementations can be made following similar principles for other standard or non-standard encoded bitstreams, where there are reference count parameters specified by the syntax of the encoded bitstreams. Dropping of layers can occur with temporal layers (e.g., frame rate), spatial layers (e.g., frame resolution), bit depth (e.g., 8-bit vs. 16-bit pixel data) or any other hierarchical layers specified by the encoding.

A bitstream processor 200 comprises a first input configured to receive the reduced encoded bitstream 202 and a second input configured to receive settings 204 indicating the parameters for which values are to be changed. The bitstream processor 200 comprises a third input configured to receive data 208 indicating the layers of the original encoded bitstream which were dropped. The bitstream processor further comprises an output configured to provide the modified, reduced encoded bitstream 206.

The bitstream processor can be implemented using computer program instructions executed on a processor that configure the processor to perform such operations. The inputs to the bitstream processor can be, for example, specified locations in memory accessed by the processor over a computer bus from which the processor reads the data for processing. Similarly, the outputs of the bitstream processor can be, for example, specified locations in memory accessed by the processor over a computer bus to which the processor writes the data for processing. The computer program instructions specify the locations in memory for the inputs and outputs and the structure of the data as stored in those locations. The settings 204 can be implemented as part of the computer program instructions, and can be conditional, based on at least the data 208 indicating the layers that are dropped. Layers can be dropped by not copying the layer to an output buffer that provides the modified, reduced encoded bitstream.

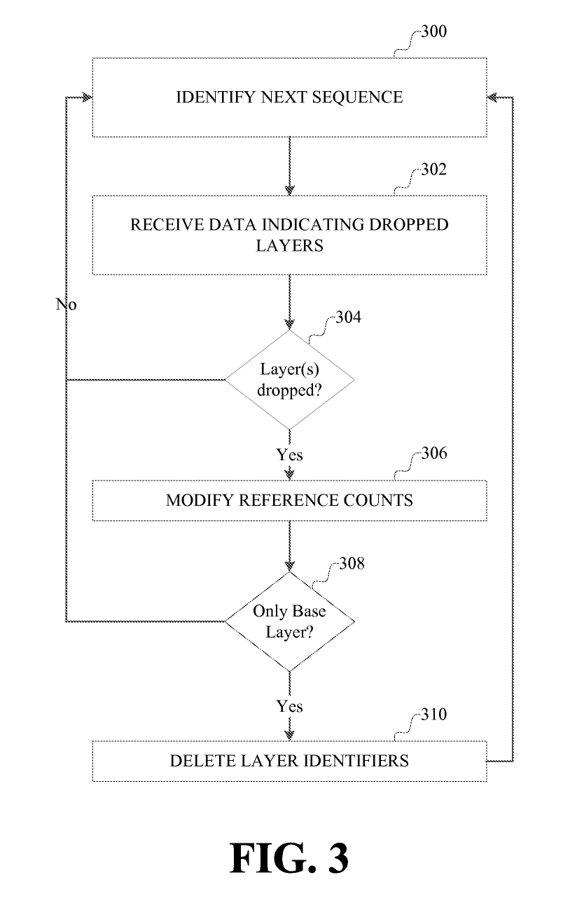

An example implementation of the operation of the bitstream processor 200 is provided by the flowchart of FIG. 3. Such a flowchart specifies a sequence of operations that can be, for example, implemented in the computer program instructions to be processed by the processor.

In this implementation in FIG. 3, it is assumed that the encoded bitstream is already a reduced encoded bitstream, and the reduced encoded bitstream is being modified. For example, the values for the reference count parameters in the reduced encoded bitstream can be modified in memory, and the memory can provide the output of the modified, reduced encoded bitstream. In such an implementation, the bitstream processor receives the indication of the layers that were dropped.

In another implementation, the encoded bitstream can be modified, as layers are being dropped, to produce the modified, reduced encoded bitstream. In such an implementation, the bitstream processor can receive an indication of layers to be dropped, and can process the encoded bitstream in memory to modify the values of parameters and output a modified, reduced encoded bitstream with the specified layers being dropped.

In FIG. 3, the bitstream processor identifies 300 any next sequence in the encoded bitstream. A sequence is any combination of encoded data for which a set of reference count parameters is provided. In an AVC-compliant bitstream, for example, the reference count parameters are located in a “sequence parameter set” which is provided for one or more groups of pictures. The bitstream processor receives 302 data indicating the number of layers that have been dropped from the current sequence the encoded bitstream. In response 304 to an indication that one or more layers have been dropped, the values for the reference count parameters are modified 306. Otherwise, the next sequence is processed at 300.

In some formats, the syntax also specifies that there is data identifying each layer. For example, in an AVC-compliant bitstream, for each unit of data for a temporal layer, there is a “prefix” that specifies a temporal layer for that unit. When processing an AVC-compliant bitstream, if a temporal layer is dropped, then each unit of data having a prefix specifying that temporal layer is removed, and the prefix for that unit also is removed. To provide further reduction of the bitstream, the bitstream processor can determine 308 whether only a base layer remains in the reduced encoded bitstream. If only the base layer remains, then any prefix or other data identifying the layer can be removed 310 from the bitstream as well.

As an example, using AVC-compliant bitstreams, the syntax for an encoded bitstream specifies that there is a parameter called “max_num_ref_frames” for each sequence. The value of this parameter indicates the maximum number of reference frames used for in the groups of pictures in the sequence. The value of this parameter can then be changed to the match the actual number of reference frames used after one or more temporal layers has been dropped.

For example, if an AVC-compliant bitstream has four temporal layers, and the value of the parameter “max_num_ref_frames” is 3, then: this value can be changed to 2 if one temporal layer is dropped; this value can be changed to 1 if two temporal layers are dropped; this value can be changed to 0 of three temporal layers are dropped.

Using an AVC-compliant bitstream, yet other parameters for a sequence also can be changed. For example, values for the parameters called “level” and “max_dec_frame_buffering”, indicating the level and number of buffering frames used for a group of pictures, also can be modified, to reduce the number of buffering frames.

As another example, using HEVC-compliant bitstreams, the syntax for an encoded bitstream specifies that there are parameters called “sps_max_dec_pic_buffering_minus1[ ]” and “sps_max_num_reorder_pics[ ]”. The values for these parameters can be modified based on the number of removed temporal layers, in order to optimize the number of reference frames and the number of buffering frames for each group of pictures.

With both AVC and HEVC-compliant bitstreams, the encoded bitstream is divided into a number of data units called network abstraction layer units (NALU or NAL units). The NAL units that contain video data of a particular temporal layer of the video data are preceded by “prefix” NAL units or prefix NALUs. The prefix NAL units include data identifying the temporal layer to which the corresponding video data NAL unit belongs. When a temporal layer is dropped, the video data NAL units of that temporal layer and their corresponding prefix NAL units are removed. If all temporal layers but the base layers are removed, then each video data NAL unit for the base layer also has a corresponding prefix NAL unit identifying the video data NAL unit as belonging to the base layer. These prefix NAL units of the base layer also can be removed if all other temporal layers are removed.

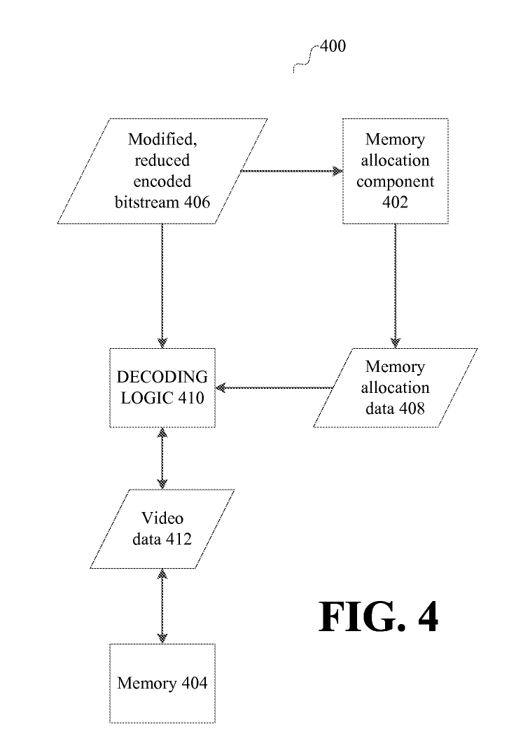

Referring now to FIG. 4, given such changes to the encoded bitstream, thus providing a modified, reduced encoded bitstream, a video decoder can allocate less memory for decoding. In particular, a video decoder 400 includes a memory allocation component 402, that allocates space in memory 404 based on at least the data in the modified, reduced encoded bitstream 406. The result of memory allocation is data 408 identifying the location of various frames in the memory 404. Decoding logic 410 uses the memory allocation information 408 to store video data 412 in the memory 404, and read video data 412 from the memory 404 for processing. The video decoder 400 can include a bitstream processor (e.g., 200 in FIG. 2). The video decoder 400 further can include bitstream processing logic that drops layers. The video decoder can be configured to receive an input indicating a number of layers to be dropped, and to drop the specified layers, and to modify the reference count parameters to provide the modified, reduced encoded bitstream to the decoding logic.

The memory allocation component can further include logic to apply syntax restrictions, to further reduce memory consumption and optimize performance. For example, to process an AVC-compliant bitstream, if the parameter called “max_num_reorder_frames” is present in the encoded bitstream, then the decoded picture buffer (DPB) size can be further restricted to the values of the parameters called “max_num_reorder_frames” and “max_num_ref_frames.” As another example, when processing an AVC or HEVC-compliant bitstream, if the parameter called picture order count (POC) type has a value set to “2”, then the decoded picture buffer size can be further restricted the value of the parameter called “max_num_ref_frames”.

The bitstream processor (e.g., 200 in FIG. 2) can be implemented in a number of ways. In some implementations, the bitstream processor can be implemented using a computer program that is executed using a central processing unit (CPU) of a device, whether the first device, network device, or second device of FIG. 1. In such an implementation, the bitstream processor accesses the encoded bitstream from memory accessible to the bitstream processor through the CPU. In some implementations, the bitstream processor can utilize and application programming interface (API) to access a library designed to facilitate access to the encoded bitstream. The graphics library may execute on a CPU only or may use coprocessor resources (such as a graphics processing unit (GPU)) as well, or may use functional logic in the host computer that is dedicated to video encoding and/or decoding operations.

In some implementations, the bitstream processor can be implemented as part of a video decoder. In some implementations, the video decoder can use a computer program that is utilizes resources of a graphics processing unit (GPU) of the host computer, or it can use dedicated video decoder hardware blocks accessible to the host computer.

In some implementations, the bitstream processor can be implemented in part using functional logic dedicated to the bitstream processing function. Such a bitstream processor includes processing logic and memory, with inputs and outputs of the bitstream processor being implemented using one or more buffer memories or registers or the like. The processing logic can be implemented using a number of types of logic device or combination of logic devices, including but not limited to, programmable digital signal processing circuits, programmable gate arrays, including but not limited to field-programmable gate arrays (FPGA's), application-specific integrated circuits (ASICs), application-specific standard products (ASSPs), systems-on-a-chip systems (SOCs), complex programmable logic devices (CPLDs), or a dedicated, programmed microprocessor. Such a bitstream processor can be implemented as a coprocessor within a device.

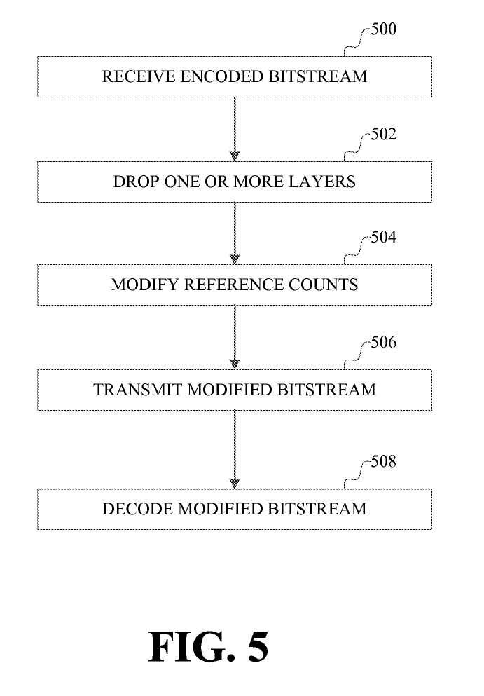

Having now described example implementations of the bitstream processor and video decoder, example implementations of their use in various stages of video processing and transmission will now be described in connection with FIGS. 5 through 7.

FIG. 5 is a flowchart of an implementation of a system using a bitstream processor in a first device that performs bitstream processing at the time of dropping one or more temporal layers, prior to or at the time of transmission. The processes shown in FIGS. 5-7 may occur in real time, such as while encoding video data in a video conferencing session, or may relate to stored video. The encoded bitstream is received 500. One or more temporal layers are dropped 502 to produce a reduced encoded bitstream. The bitstream processor processes 504 the reduced encoded bitstream to produce the modified reduced encoded bitstream targeted for the second device. The first device transmits 506 the modified reduced encoded bitstream to the second device, where it can be decoded 508.

An implementation such as in FIG. 5 can be used, for example, where the first device is aware of the capabilities of multiple second devices, or their network connections, and wherein one of the second devices receives the full encoded bitstream, but where the second device uses only a reduced encoded bitstream.

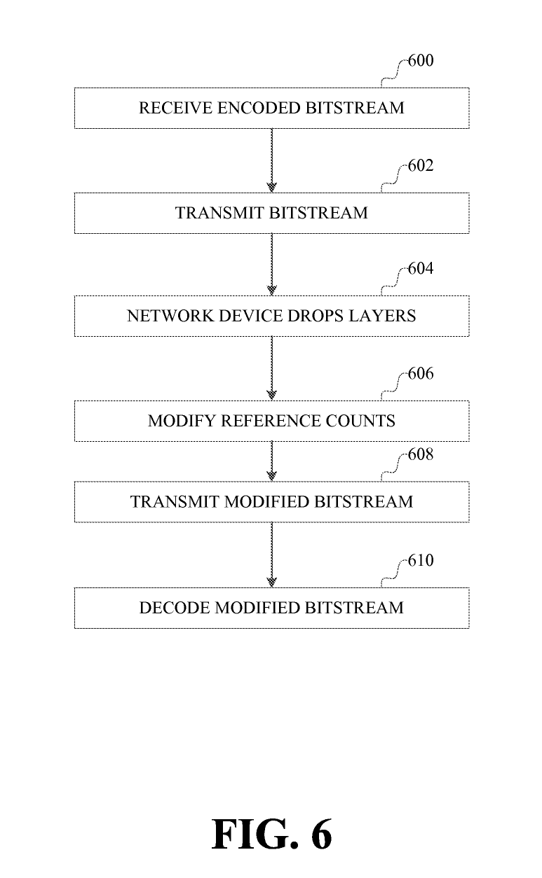

FIG. 6 is a flowchart of an implementation of a system using a bitstream processor in a network device that performs bitstream processing during transmission of an encoded bitstream. The encoded bitstream is received 600. The first device transmits 602 the encoded bitstream to the second device over the computer network. A network device drops 604 one or more temporal layers to produce a reduced encoded bitstream. The bitstream processor processes 606 the reduced encoded bitstream to produce the modified reduced encoded bitstream targeted for the second device. The network device transmits 608 the modified reduced encoded bitstream to the second device, where it can be decoded 610.

An implementation such as shown in FIG. 6 can be used, for example, where the network device is aware of the capabilities of a second device to which it is transmitting, or the network connection to the second device over which it is transmitting. The network device can make a determination whether the second device receives the full encoded bitstream or a reduced encoded bitstream.

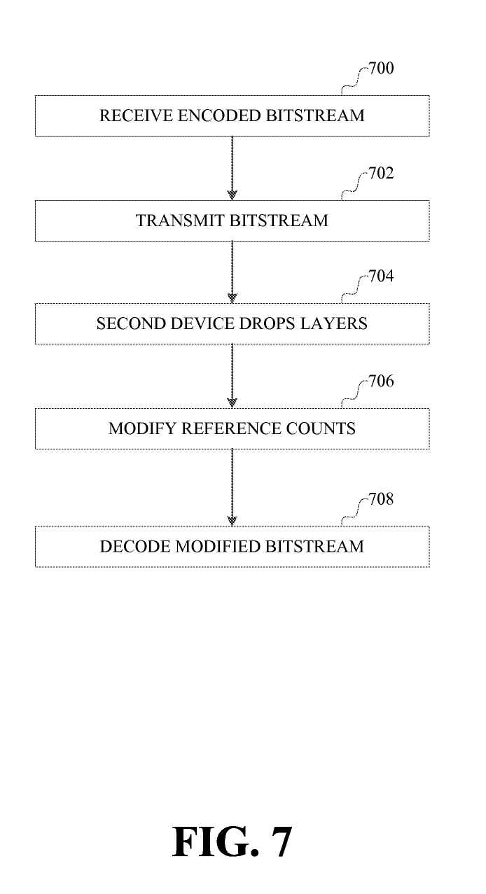

FIG. 7 is a flowchart of an implementation of a system using a bitstream processor of a second device that performs bitstream processing prior to or at the time of decoding. The encoded bitstream is received 700. The first device transmits 702 the encoded bitstream to the second device over the computer network. The second device drops 704 one or more temporal layers to produce a reduced encoded bitstream. The bitstream processor processes 706 the reduced encoded bitstream to produce the modified reduced encoded bitstream. The video decoder in the second device then decodes 708 the bitstream.

An implementation such as shown in FIG. 7 can be used, for example, where the second device stores the received data for later processing or playback, or where the second device decodes and displays or processes the video data, and the bit rate used by the second device is lower than the bit rate of the received encoded bitstream.

The various example implementations provided above are merely illustrative and are not intended to be either exhaustive or limiting. In various implementations, a bitstream processor configured to modify the values of the reference count parameters in a reduced encoded bitstream allows a video decoder in turn to allocate a different amount of memory for decoding. Such modifications can be made by processing the encoded bitstream without re-encoding the encoded video data. These modifications improve the utilization of memory by the video decoder, thus improving performance of the second device.

Having now described an example implementation, FIG. 8 illustrates an example of a computer in which such techniques can be implemented, whether implementing the first device, network device or second device. This is only one example of a computer and is not intended to suggest any limitation as to the scope of use or functionality of such a computer.

The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones, personal data assistants, voice recorders), server computers, multiprocessor systems, microprocessor-based systems, programmable consumer electronics, networked personal computers, minicomputers, mainframe computers, network devices and distributed computing environments that include any of the above types of computers or devices, and the like.

With reference to FIG. 8, an example computer 800 includes at least one processing unit 802 and memory 804. The computer can have multiple processing units 802. A processing unit 802 can include one or more processing cores (not shown) that operate independently of each other. Additional co-processing units, such as graphics processing unit 820, also can be present in the computer. The memory 804 may be volatile (such as dynamic random access memory (DRAM) or other random access memory device), non-volatile (such as a read-only memory, flash memory, and the like) or some combination of the two. The memory also can include registers or other storage dedicated to a processing unit or co-processing unit 820. This configuration of memory is illustrated in FIG. 8 by line 806. The computer 800 may include additional storage (removable and/or non-removable) including, but not limited to, magnetically-recorded or optically-recorded disks or tape. Such additional storage is illustrated in FIG. 8 by removable storage 808 and non-removable storage 810. The various components in FIG. 8 are generally interconnected by an interconnection mechanism, such as one or more buses 830.

A computer storage medium is any medium in which data can be stored in and retrieved from addressable physical storage locations by the computer. Computer storage media includes volatile and nonvolatile memory, and removable and non-removable storage media. Memory 804 and 806, removable storage 808 and non-removable storage 810 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. The computer storage media can include combinations of multiple storage devices, such as a storage array, which can be managed by an operating system or file system to appear to the computer as one or more volumes of storage. Computer storage media and communication media are mutually exclusive categories of media.

Computer 800 may also include communications interface(s) 812 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, radio frequency, infrared and other wireless media. Communications interfaces 812 are devices, such as a wired network interface, wireless network interface, radio frequency transceiver, e.g., Wi-Fi, cellular, long term evolution (LTE) or Bluetooth, etc., transceivers, navigation transceivers, e.g., global positioning system (GPS) or Global Navigation Satellite System (GLONASS), etc., transceivers, that interface with the communication media to transmit data over and receive data from communication media, and may perform various functions with respect to that data.

Computer 800 may have various input device(s) 814 such as a keyboard, mouse, pen, stylus, camera, touch input device, sensor (e.g., accelerometer or gyroscope), and so on. The computer may have various output device(s) 816 such as a display, speakers, a printer, and so on. All of these devices are well known in the art and need not be discussed at length here. The input and output devices can be part of a housing that contains the various components of the computer in FIG. 8, or can be separable from that housing and connected to the computer through various connection interfaces, such as a serial bus, wireless communication connection and the like. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, hover, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (such as electroencephalogram techniques and related methods).

The various storage 810, communication interfaces 812, output devices 816 and input devices 814 can be integrated within a housing with the rest of the computer, or can be connected through input/output interface devices on the computer, in which case the reference numbers 810, 812, 814 and 816 can indicate either the interface for connection to a device or the device itself as the case may be.

A computer generally includes an operating system, which is a computer program that manages access to the various resources of the computer by applications. There may be multiple applications. The various resources include the memory, storage, communication devices, input devices and output devices, such as display devices and input devices as shown in FIG. 8.

The operating system and applications can be implemented using one or more processing units of one or more computers with one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Accordingly, in one aspect, a video processing system comprises an input configured to receive an initial encoded bitstream comprising encoded video data and values for reference count parameters into memory, the encoded video data comprising a plurality of layers, a bitstream processor configured to remove encoded video data for one or more of the plurality of layers from the initial encoded bitstream and to modify a value of at least one reference count parameter in the initial encoded bitstream, to provide a modified reduced encoded bitstream, and an output configured to provide the modified reduced encoded bitstream.

In another aspect, a process of generating an encoded bitstream comprises receiving a reduced encoded bitstream derived from an initial bitstream of encoded video data into memory, the encoded video data comprising a plurality of layers, the reduced encoded bitstream having encoded video data for one or more of the plurality of layers removed from the initial bitstream. The reduced encoded bitstream is processed to modify a value of at least one reference count parameter related to the removed one or more of the plurality of layers, to output a modified reduced encoded bitstream.

In another aspect, a computer program product comprises computer storage and computer program instructions stored on the computer storage which, when processed by a computer, configure the computer to perform a process of generating an encoded bitstream. A reduced encoded bitstream derived from an initial bitstream of encoded video data is received into memory. The encoded video data comprises a plurality of layers. The reduced encoded bitstream has encoded video data for one or more of the plurality of layers removed from the initial bitstream. The reduced encoded bitstream is processed to modify a value of a reference count parameter related to the removed one or more of the plurality of layers.

In another aspect a device comprises means for receiving a reduced encoded bitstream derived from an initial bitstream of encoded video data into memory, the encoded video data comprising a plurality of layers, the reduced encoded bitstream having encoded video data for one or more of the plurality of layers removed from the initial bitstreams, and means for modifying a value of at least one reference count parameter related to the removed one or more of the plurality of layers, to output a modified reduced encoded bitstream

In any of the foregoing aspects, the reference count parameter can be an indication of a number of reference frames, and/or an indication of a number of buffering frames and/or any other information used by a video decoder to allocate memory for decoding the encoded video data of the encoded bitstream.

In any of the foregoing aspects, layer identification information, such as prefix network access layer units, related to a base layer can be removed if all other layers have been removed.

In any of the foregoing aspects, a device configured to receive the modified reduced encoded bitstream can includes a video decoder.

In any of the foregoing aspects, a first device can generate the modified reduced encoded bitstream and can transmit the modified reduced encoded bitstream to a second device. A first device can transmit the initial encoded bitstream, and a network device can generate the modified reduced encoded bitstream and transmit the modified reduced encoded bitstream to a second device. A first device can transmit the initial encoded bitstream to a second device, and the second device can generate the modified reduced encoded bitstream. The second device can include a video decoder.

In any of the foregoing aspects, a video decoder can be configured to allocate memory based at least on the modified value of the reference count parameter. The video decoder can be further configured to apply syntax restrictions according to the reduced reference counts. The video decoder can be further configured to limit a decoded picture buffer size according to at least the modified value of the reference count parameter.

In any of the foregoing aspects, the initial bitstream can be processed by a bitstream processor to remove the one or more of the plurality of layers and to modify the values of the reference count parameters.

Any of the foregoing aspects may be embodied in one or more computers, as any individual component of such a computer, as a process performed by one or more computers or any individual component of such a computer, or as an article of manufacture including computer storage with computer program instructions are stored and which, when processed by one or more computers, configure the one or more computers.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A video processing system, comprising:
an input configured to receive an initial encoded bitstream comprising encoded video data and values for reference count parameters into memory, the encoded video data comprising a plurality of layers;
a bitstream processor configured to remove encoded video data for one or more of the plurality of layers from the initial encoded bitstream and to modify a value of at least one reference count parameter in the initial encoded bitstream, to provide a modified reduced encoded bitstream;
an output configured to provide the modified reduced encoded bitstream.

2. The video processing system of claim 1, wherein the reference count parameter comprises an indication of a number of reference frames.

3. The video processing system of claim 1, wherein the reference count parameter comprises an indication of a number of buffering frames.

4. The video processing system of claim 1, wherein the bitstream processor is further configured to remove prefix network access layer units related to a base layer if all other layers have been removed.

5. The video processing system of claim 1, further comprising a video decoder configured to allocate memory based at least on the modified value of the reference count parameter.

6. The video processing system of claim 5, wherein the video decoder is further configured to apply syntax restrictions according to the reduced reference counts.

7. The video processing system of claim 5, wherein the video decoder is further configured to limit a decoded picture buffer size according to at least the modified value of the reference count parameter.

8. A process of generating an encoded bitstream comprising:
receiving a reduced encoded bitstream derived from an initial bitstream of encoded video data into memory, the encoded video data comprising a plurality of layers, the reduced encoded bitstream having encoded video data for one or more of the plurality of layers removed from the initial bitstream; and
processing the reduced encoded bitstream to modify a value of at least one reference count parameter related to the removed one or more of the plurality of layers, to output a modified reduced encoded bitstream.

9. The process of claim 8, wherein the reference count parameter comprises an indication of a number of reference frames.

10. The process of claim 8, wherein the reference count parameter comprises an indication of a number of buffering frames.

11. The process of claim 8, further comprising removing a prefix network access layer unit for a base layer when all other layers have been removed.

12. The process of claim 8, further comprising decoding the modified reduced encoded bitstream, the decoding further comprising allocating memory based at least on the modified value of the reference count parameter.

13. The process of claim 12, wherein the decoding further comprises applying syntax restrictions according to the modified value of the reference count parameter.

14. The process of claim 12, wherein the decoding further comprises limiting a decoded picture buffer size according to at least the modified value of the reference count parameter.

15. A computer program product comprising:
computer storage;
computer program instructions stored on the computer storage which, when processed by a computer, configure the computer to perform a process of generating an encoded bitstream comprising:
receiving a reduced encoded bitstream derived from an initial bitstream of encoded video data into memory, the encoded video data comprising a plurality of layers, the reduced encoded bitstream having encoded video data for one or more of the plurality of layers removed from the initial bitstream; and
processing the reduced encoded bitstream to modify a value of a reference count parameter related to the removed one or more of the plurality of layers.

16. The computer program product of claim 15, wherein the reference count parameter comprises an indication of a number of reference frames.

17. The computer program product of claim 15, wherein the reference count parameter comprises an indication of a number of buffering frames.

18. The computer program product of claim 15, wherein the process further comprises removing a prefix network access layer unit of a base layer when all other layers are removed.

19. The computer program product of claim 15, wherein the process further comprises decoding the modified reduced encoded bitstream, the decoding further comprising allocating memory based at least on the modified value of the reference count parameter.

20. The computer program product of claim 19, wherein the decoding further comprises applying syntax restrictions according to the modified value of the reference count parameter.
